(19) United States
(12) Patent Application Publication
(10) Pub. No.: US 2008/0120125 A1
(43) Pub. Date: May 22, 2008

(54) CONTACT CENTER RESOURCE SUBSCRIPTION NOTIFICATION

(75) Inventor: David L. Chavez, Broomfield, CO (US)

Correspondence Address: SHERIDAN ROSS P.C., 1560 BROADWAY, SUITE 1200, DENVER, CO, 80202, US

(73) Assignee: AVAYA TECHNOLOGY LLC, Basking Ridge, NJ (US)

(21) Appl. No.: 11/754,636

(22) Filed: May 29, 2007

Related U.S. Application Data
(60) Provisional application No. 60/866,313, filed on Nov. 17, 2006.

(51) Int. Cl. G06Q 10/00; G06F 17/40

(52) U.S. Cl. 705/1; 707/104.1

(57) ABSTRACT

A contact center is provided that includes an input operable to receive work items 204a-w, a work item processing agent 200 to populate work item containers 212a-i with information respecting the received work items, and a notification agent 216 to notify subscribing entities of state changes in the work item containers. The processing agent transfers work items to a subscribing entity when requested by the subscribing entity via a subscription notification comprising an applet or serve-let.

### CROSS REFERENCE TO RELATED APPLICATIONS

This application claims priority to U.S. Provisional Patent Application No. 60/866,313, entitled “Contact Center Agent Work Awareness Algorithm” and filed by Chavez et al. on Nov. 17, 2006, which is incorporated herein by reference.

### FIELD OF THE INVENTION

The present application is directed generally to contact centers and specifically to methodologies and systems for servicing work such as contacts using external resources.

### BACKGROUND OF THE INVENTION

In Automatic Contact-Distribution (ACD) systems, contacts incoming to a contact center are answered and handled by a plurality of resources. The ACD system automatically distributes and connects incoming contacts to whatever resource, such as agents, have the skill set suited to handle the contacts and are free, i.e., not handling other contacts at the moment. As used herein, a “contact” refers to any mode or type of contact between two entities, including without limitation voice calls, VoIP, text-chat, e-mail, fax, electronic documents, web forms, voice messages, and video calls, to name but a few.

Due to the random and peaked nature of inbound contacts from customers, a contact center frequently becomes overloaded when no suitable resources are available to handle contacts as the contacts come in. The contacts are placed in different queues based upon some preestablished criteria, such as business/service policies, objectives, and goals for each contact type, and are placed in each queue in the order of their arrival and/or priority. Numerous techniques have been devised for determining an actual or anticipated wait time for each enqueued item, and the enqueued items are typically serviced based on the actual and/or anticipated wait time. In more elaborate systems, business/service policies, objectives, and goals and/or the degree to which they are realized are considered in selecting which work item is to be routed to an available resource. As will be appreciated, a “work item” can be a voice call to answer/service, an email to respond to, a web chat session needing an answer, an instant message to answer/service, and the like. Although this approach is effective in many applications, the approach can lead to a valuable resource being tied up on a work item of little value, not only causing inefficient use of contact center resources but also leading to frustration of more valuable customers due to long wait times and/or service by a less skilled resource.

This problem is at least partly attributable to the inability of resources (e.g., agents) to preview work items before the work item is transferred to the resource and the inability of undedicated resources to log in and service work items during the often brief or randomly occurring periods when such contact center representatives have time away from other job responsibilities to assist the contact center resources in servicing contacts. Information about the work item is normally provided to the resource after the ACD has already determined that the resource is the optimal resource to service the item. Resources, particularly highly skilled agents such as Subject Matter Experts or SMEs, need to be able to pre-view not just a selected work item but all work items that are available and not yet handled and determine, using their own judgment, whether they are the optimal selection to service the work item. Information unknown to the ACD, such as pre-existing relationships between the SME and a selected contactor, could then be considered in the work item distribution process.

### SUMMARY OF THE INVENTION

These and other needs are addressed by the various embodiments and configurations of the present invention. The present invention is directed generally to the application of presence to a work distribution architecture.

In a first embodiment of the present invention, a method for servicing work items is provided that includes the steps of:

(a) maintaining a set of work item containers, each work item container receiving a work item for servicing by a resource, and each container having information sufficient for the receiver of the work item to fully address the work item without the need of a secondary link for data for retrieval or update;

(b) when a state of a selected work item container changes, determining a set of entities that have subscribed to be notified of a state change in the selected work item; and

(c) notifying each of the members of the set of entities of the state change.

In a second embodiment, a method for servicing work items is provided that includes the steps of:

(a) subscribing to a work item container and/or a queue of work item containers on behalf of a resource, the subscription requesting the subscribing entity to be notified of a state change in the work item container and/or queue of work item containers;

(b) in response to a state change in the work item container and/or queue of work item containers, receiving a notification, the notification comprising information respecting a work item associated with the work item container and/or queue of work item containers;

(c) providing the information to the resource;

(d) receiving, from the resource, a selection of the work item; and

(e) requesting the transfer of the work item to a communication device associated with the resource to permit the resource to service the work item.

(f) providing to the resource the link to fully service the work item.

In one configuration, the invention addresses the problem of providing the current status of pending work items to be assigned to available contact center resources by using a Session Initiation Protocol (SIP) presence server-based centralized or distributed agent work distribution algorithm. The algorithm performs the agent work distribution capability by using attributes associated with pending work items that are maintained by SIP presence watcher (e.g., user agent) techniques. Such techniques are currently used to track the use of voice call endpoints by a person who may use several different voice call endpoints, thereby permitting a contactor to know which of the voice call endpoints the contact should be directed to without needing to poll or search all of the possible voice endpoints.

The information about the contactor maintained for each pending work item can include, for example, name, company name, account information, wait time, and work item priority. Other information may be maintained depending upon the application.

The information is provided to subscribing entities through notification messages. The work item information is updated by a SIP-like monitoring technique that passes status information about a work item from an entity, such as a Private Branch eXchange or PBX, database interface, email server, video web chat server, and the like, to a work item presence server, which preferably is a SIP-like presence server. Using notification messages, the current status of the work item information can be accessed by applications having a presence server interface capability and access permission to access the information. The application can then display some or all of the waiting work items that the resource can respond to via a computer terminal user interface. Detailed information about a waiting work item is included in the information accessible by the application, thereby permitting the resource to use his or her judgment to select manually which work item to respond to next. Optionally, the contact center work distribution algorithm can provide an automated recommendation to the resource as to which work item to choose next based on the application's internal rules engine. Thus, the resource has the ability to select any waiting work item to respond to next rather than letting the work distribution algorithm make the decision.

In one configuration, the notification message from the Agent Work Awareness Algorithm (“AWAA”) server includes an applet or a serve-let that is downloaded onto a resource's communication device. The applet interacts with the resource to assist the resource in selecting from a plurality of AWAA server work items made known to the resource either “visibly” or “invisibly” by the downloaded applet or serve-let. This includes the communication information or dialog or link to hosted query engine that prompts the resource for what further information to get from the contactor or customer, instructs the resource how to respond to questions and answers received from the customer and provides the interface to update host information about the contactor in the databases used by the contact center provider.

In one configuration, the applet or serve-let provides the resource with information sufficient for the resource to service fully the work item if selected by the resource without the need of a secondary link (other than any link embedded in the applet) for data for retrieval or update. In other words, the applet is downloaded automatically, through the resource's Web browser onto the resource's communication device and executed on the resource's device. The applet interacts with the resource to assist the resource in collecting information from the customer and responding to the questions of the customer. It also interfaces with the contact center database to retrieve information from and update information on the database without the need for the secondary link. For example, the applet can include embedded links to information storage locations, such as database addresses, to access information and user interfaces, such as Web pages, for completion by the resource during servicing of the work item.

The present invention can provide a number of advantages depending on the particular configuration. For example, the contact center provides a simple and efficient interface to undedicated agents, such as SME's, to service work items on an as-available basis. This can provide substantial improvements in customer satisfaction and realization of service level goals and policies as well as providing a higher level of utilization of enterprise personnel resources. Using a SIP-type mechanism to expose potential agent work to agents, the interface is readily adaptable for use with off-site personnel, whether in a home office or in a contractor's facility and does not require specific hardware or software in the remote endpoint for compatibility. The interface is generally agnostic to the database and access mechanisms of the contact center. The resource can use standard SIP signaling to interface with the contact center through, for example, a Personal Computer, a laptop, or desktop, whether at home or work. This capability permits a contact center to interface readily with ACD's of other manufacturers that provide a AWAA-compliant SIP-based interface to an AWAA-compliant SIP presence service. With such a compliant interface, the AWAA technique allows offloading work items from a primary work facility to contractors or other enterprise locations.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of a contact center according to an embodiment of the present invention;

FIG. 2 is a block diagram of entities in the contact center of FIG. 1;

FIG. 3 is a flow chart depicting an operational embodiment of the contact center;

FIG. 4 is a flow chart depicting an operational embodiment of the contact center;

FIG. 5 is a flow chart depicting an operational embodiment of the contact center; and

FIG. 6 is a block diagram depicting an operational embodiment of the contact center.

### DETAILED DESCRIPTION

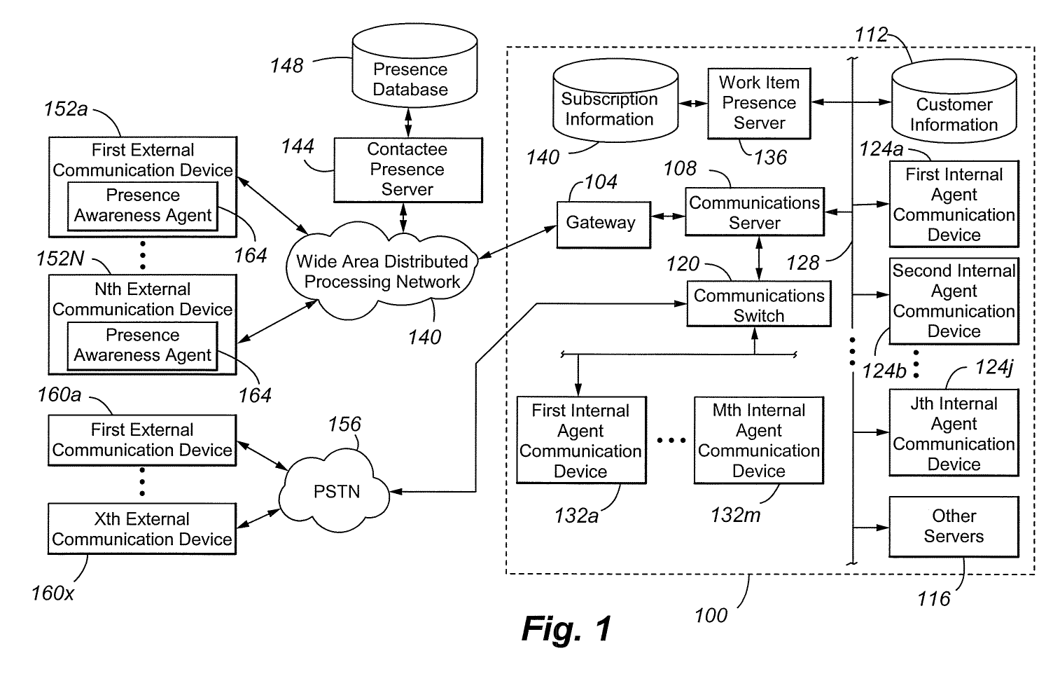

FIG. 1 shows an illustrative embodiment of the present invention.

An enterprise contact center denoted by dashed lines 100 comprises a gateway 104, central communications server, a set of data stores or databases 112 containing contact or customer related information and other information that can enhance the value and efficiency of the contact, a plurality of application servers 116, first, second, . . . jth internal packet-switched communication devices 124a-j, a work item presence server 136 and associated database 140 containing subscription information, all interconnected by a trusted local area network LAN (or wide area network WAN) 128, and a switch 120 controlling first, . . . mth internal circuit-switched communication devices 132a-m.

The gateway 104 can be any suitable device for controlling ingress to and egress from the corresponding LAN. The gateway is positioned logically between the other components in the corresponding enterprise premises and the network 140 to process communications passing between the server and the network 140. The gateway 124 typically includes an electronic repeater functionality that intercepts and steers electrical signals from the network 140 to the corresponding LAN 128 and vice versa and provides code and protocol conversion. Examples of suitable gateways include Avaya Inc.'s, G700™, G650™, G350™, MCC/SCC™ media gateways and Acme Packet's Net-Net 4000 Session Border Controller.

The communications server 108 and switch 120 direct communications, such as incoming Voice Over IP or VoIP and telephone calls, in the enterprise network. The terms “switch”, “server”, and “switch and/or server” as used herein should be understood to include an ACD, a Private Branch Exchange PBX (or Private Automatic Exchange PAX) an enterprise switch, an enterprise server, or other type of telecommunications system switch or server, as well as other types of processor-based communication control devices such as media servers, computers, adjuncts, etc. The switch/(media) server can be any architecture for directing contacts to one or more communication devices. Illustratively, the switch and server of FIG. 1 can be a modified form of Avaya Inc.'s Definity™ Private-Branch Exchange (PBX)-based ACD system or MultiVantage™ PBX running modified Advocate™ software, CRM Central 2000 Server™, Communication Manager™, S8300™ media server, SIP Enabled Services™, and/or Avaya Interaction Center™.

The first, second, . . . jth communication devices 124a-j are preferably packet-switched stations or communication devices, such as IP hardphones (e.g., Avaya Inc.'s 4600 Series IP Phones™), IP softphones (e.g., Avaya Inc.'s IP Softphone™), Personal Digital Assistants or PDAs, Personal Computers or PCs, laptops, packet-based H.320 video phones and conferencing units, packet-based voice messaging and response units, peer-to-peer based communication devices, and packet-based traditional computer telephony adjuncts. Examples of suitable devices are the 4610™, 4621 SW™, and 9620™ IP telephones of Avaya, Inc.

The first, . . . mth communication devices 132a-m are preferably circuit-switched and/or TDM devices. As will be appreciated, the devices are normally plugged into a Tip ring interface that causes electronic signals from the station to be placed onto a TDM bus (not shown). Each of the stations corresponds to one of a set of internal (Direct-Inward-Dial) extensions on its controlling switch/server. The switch 120 can direct incoming contacts to and receive outgoing contacts from these extensions in a conventional manner. The devices 132a-m can include, for example, wired and wireless telephones, PDAs, H.320 video phones and conferencing units, voice messaging and response units, and traditional computer telephony adjuncts. Examples of suitable devices are the 30010™, 2410™, and 2420™ Digital Telephones of Avaya, Inc.

The other servers 116 can include a variety of application servers, such as a fax server, web server, a data network server, an email server, instant messaging server, scanner, interactive voice recognition IVR software, VoIP software, video call software, voice messaging software, an IP voice server and proxy servers.

The work item presence server 136 and subscription information 140, as described more fully below, tracks the “presence”, or state, of a plurality of work item containers, that may or may not be currently associated with an active work item, and provides notification of state changes to subscribing entities. “State” refers to properties of an object that characterize the object's current condition. Examples of subscribing entities are denoted as presence awareness agents 164 in the first, . . . nth external communication devices 152a-n. Presence awareness agents 164 may be associated with functional components other than communication devices, such as other communications servers of the same or a different enterprise, a communications switch of the same or a different enterprise, internal communication devices, a database interface, an application server (e.g., email server, instant message server, video web chat server, etc.), and the like.

The enterprise contact center 100 is connected, via wide area distributed processing network 140 to a subscriber presence server 144 and associated presence database 148 and first, . . . nth external packet-switched communication devices 152a-n, and, via Public Switched Telephone Network (PSTN) 156, to first, . . . xth external circuit-switched communication devices 160a-x. The WAN 140 is preferably an untrusted network, such as the Internet. The first, . . . nth and first, . . . xth external communication devices 152a-n can be any of the communication devices described above. An “external” communication device is not controlled by an enterprise switch/server (e.g., does not have an extension serviced by the switch/server) while an “internal” device is controlled by an enterprise switch/server.

The contactee presence server 144 and associated presence information database 148 may or may not be operated by the enterprise. The presence server 144 and presence information database 148 collectively track the presence and/or availability of contactees and/or their communication devices and provide, to requesting user agents in communication devices, current presence information respecting selected contactees. As used herein, “presence information” refers to any information associated with a network node and/or endpoint device, such as a communication device, that is in turn associated with a person or identity. Presence information generally indicates what kind of context the contactee is in and what kind of communication, if any, is appropriate to reach successfully the contactee. Examples of presence information include information regarding the accessibility of the endpoint device, the recency of use of the endpoint device by the person, recency of authentication by the person to a network component, and the preferences of the person (e.g., contact mode preferences or profiles such as the communication device to be contacted for specific types of contacts or under specified factual scenarios, contact time preferences, impermissible contact types and/or subjects such as subjects about which the person does not wish to be contacted, and permissible contact type and/or subjects such as subjects about which the person does wish to be contacted).

The present invention may be used with either a client-server architecture or a peer-to-peer architecture, such as those envisioned by the Session Initiation Protocol and SIP Instant Messaging and Presence Leveraging Extensions or SIMPLE. In the client-server model or paradigm, network services and the programs used by end users to access the services are described. The client side provides a user with an interface for requesting services from the network, and the server side is responsible for accepting user requests for services and providing the services transparent to the user. By contrast in the peer-to-peer model or paradigm, each networked host runs both the client and server parts of an application program. Moreover, the invention does not require a specific Internet Protocol Telephony (IPT) protocol and could be implemented, for example, using QSIG, H.323, and combinations thereof. Additionally, the invention does not require the presence of packet- or circuit-switched networks.

Before discussing further the present invention, it is important to understand how SIP and SIMPLE operate in the context of a contactee presence server 144. A user agent in a communication device sends a SUBSCRIBE request to the presence server 144. The SUBSCRIBE is a soft subscription (it has a timer and expires if not renewed). While the subscription is active, the user agent is sent a NOTIFY by the presence server 144 whenever the status of the entity, which is the subject of the subscription, changes. The NOTIFY is used to push presence updates to all subscribers. In other words, the NOTIFY contains information relating to the status update.

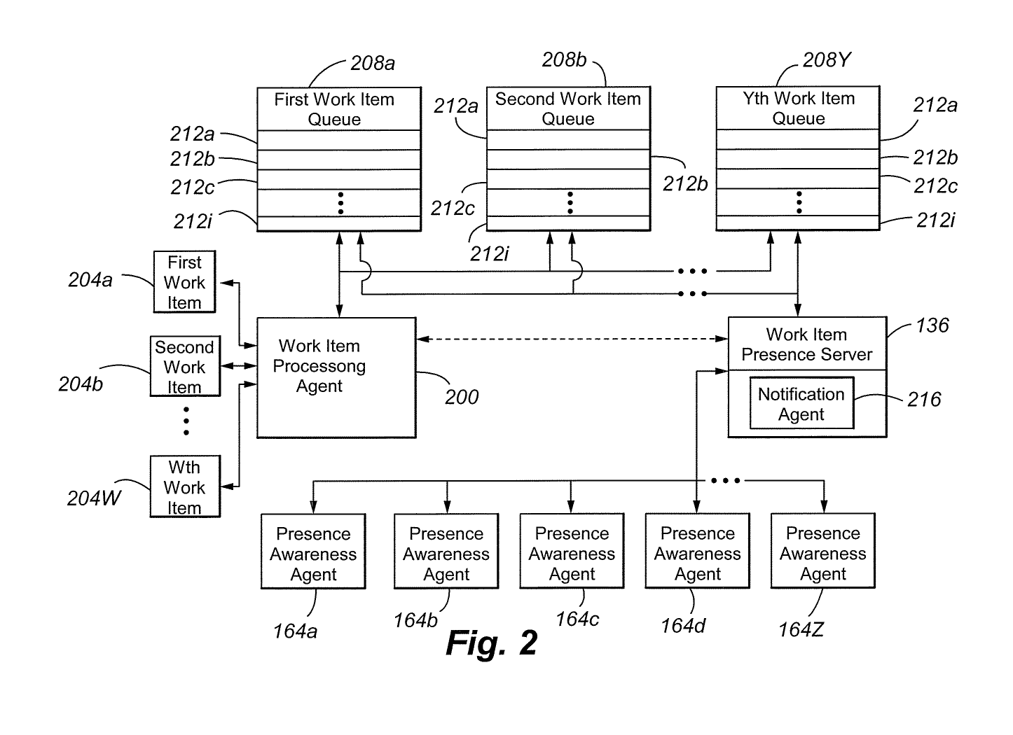

The SUBSCRIBE and NOTIFY messages are used by embodiments of the present invention to assign work items with an appropriate servicing resource. This feature will be discussed with reference to FIG. 2, which illustrates an exemplary architecture according to an embodiment of the present invention.

Referring to FIG. 2, the work item processing agent 200 receives incoming and/or outgoing work items 204a-w (e.g., contacts), processes the work items using information in the customer information database 112, and directs the work items to an appropriate work item queue 208a-y. Each work item queue 208a-y corresponds to a different set of resource skills. Each queue 208a-y includes a plurality of work item containers 212a-i that may or may not be associated with an active work item. The relative locations of the work item containers 212a-i in a queue 208a-y may or may not be associated with a relative priority of the associated work item. For example, the work item container at the head of the queue may not be deemed to be the most important work item in a given queue to be next served. Typically however, work items are prioritized and either are queued in individual ones of the queues 208a-y in their order of priority or are queued in different ones of a plurality of queues that correspond to a different priority.

When a work item is assigned to a work item container 212a-i, the assigned work item container includes information respecting the associated work item, such as customer identity (e.g., customer name, company name, account information, etc.), customer type (e.g., gold, silver or bronze), work item intent or purpose (e.g., purchase, service or assistance, warranty claim, etc.), customer personal information (e.g., home address, telephone number, credit card number, bank account information, etc.), customer transaction history (e.g., dates, item types purchased, and amounts of customer purchases), work item browser history (e.g., web pages accessed by customer in the current contact), customer order details (e.g., shopping cart contents), customer contact mode (e.g., circuit-switched phone, VoIP call, instant message, etc.), timestamp (e.g., timestamp when work item received, timestamp when work item placed in queue, etc.), work item priority in relation to other waiting work items, expected or predicted amount of time that the work item may be routed to a resource (when all resources are busy and a resource may become available in the future), identification of which switch locations having resources who may be able to receive the waiting work item, a Universal Resource Locator or URL such as of a series of Web pages provided by the enterprise to the customer associated with the work item, a pointer to the current location of the contact, and other work item information that may be important to assign a waiting work item to an available set of resources. It also contains all relevant mechanisms for a resource to prompt the customer for additional information or requests, and to input those requests securely into the contact center database without the need of a secondary link (like CTI) to cause an associated action on a computer terminal in the servicing of the work item. Some of this information is obtained from the customer information database 112.

A servicing resource queue (not shown) may optionally correspond to each of the work item queues. The resource queues may include internal resources, external resources, or combinations thereof. A “resource” may be automated or nonautomated, such as a human agent. Normally, each resource's skills are prioritized according to his or her level of expertise in that skill, and either resources are queued in individual ones of resource queues in their order of expertise level or are queued in different ones of a plurality of resource queues that correspond to a skill and each one of which corresponds to a different expertise level. “Skill” generally refers to an ability, proficiency, and/or expertness of an agent and is not limited to skill as the term is traditionally used in contact centers. Work items are assigned by the work item processing agent 200 to different work item queues 208a-y based upon a number of predetermined criteria, including customer identity, customer needs, contact center needs, current contact center queue lengths, customer value, and the resource skill that is required for the proper handling of the contact.

This embodiment is particularly suited for a Customer Relationship Management (CRM) environment in which customers are permitted to use any media to contact a business. In a CRM environment, both realtime and non-realtime contacts must be handled and distributed with equal efficiency and effectiveness. Within each set of queues, each queue holds contacts of a different priority and/or different type (e.g., e-mail, fax, electronic or paper documents, webform submissions, voice messages, voice calls, VoIP calls, text chat, video calls, and the like). Each queue normally functions as a first-in, first-out (FIFO) buffer memory.

When a work item container is populated initially or updated, a NOTIFICATION is generated and sent by the notification agent 216 in the work item presence server 136 to presence awareness agents 164a-z that have previously subscribed to the corresponding work item queue 208a-i and/or a member of a set of work item containers in the queue 208. The subscription is effected by means of a SUBSCRIBE message generated by the presence awareness agent 164, when the corresponding user/resource logs in or, after login, in response to the corresponding user/resource interacting with the agent 164, and sent to the work item presence server 136. When a subscription is received by the work item presence server 136, the subscribing presence awareness agent 164 normally receives a NOTIFICATION for each currently occupied work item container to which the subscription applies. A NOTIFICATION is not normally generated for unoccupied work item containers. A NOTIFICATION can be received and work item container contents accessed by applications having a presence awareness agent 164 and permission to access the information.

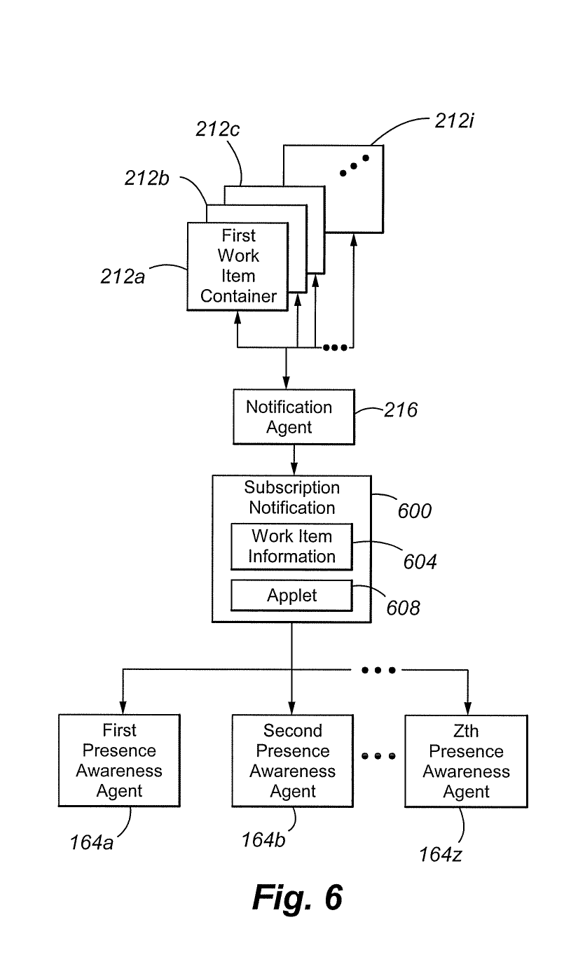

In one configuration and as shown in FIG. 6, the NOTIFICATION 600 contains information 604 related to the work item in the respective container. The information, for example, includes any of the information contained in the respective container. The information is normally included in the message header or body or in an attachment as eXtensible Markup Language or XML. The NOTIFICATION 600 can be a vehicle to push such information to the presence awareness agent 164 and/or provide sufficient information to the agent 164 to permit the agent 164 to pull selected items of information from the container. In this manner, the various resources can preview the various enqueued work items and select a work item for servicing that is an optimal match.

In another configuration, the NOTIFICATION 600, in addition to containing the information noted above, can contain resource interactive instructions and/or suggestions, in the form of a serve-let or applet 608, respecting the interaction with the work item contactor. The instructions are normally in the form of a JAVA program or thin client interface that is downloaded to the communication device of which the presence aware agent 164 is part. The instructions have a schema attached to the data that is being entered by the resource so that when the populated instructions are returned to the communications server 108 little additional data processing is required. For example, the instructions may be in the form of a Graphical User Interface or GUI display having fields that are populated by the servicing resource. When the work item is serviced, the collected information, such as in the form of the GUI display containing values in the various fields, is pushed back to the communications server 108. In this way, the resource may service the work item using a general platform, such as a PC at home, remotely from a laptop computer, or desktop computer at work. There is no requirement that the resource be interfacing directly with the customer information database 112. It is thus agnostic to the specific database requirements and access mechanisms of the enterprise 100.

In one configuration, first and second sets of resources are provided that correspond, respectively, to employees and nonemployees of the business or enterprise 100. For example, the second set of resources, which correspond to external communication devices 152a-n and 160a-x, can be contractors, subcontractors, employees of another organization, such as a bidding house, and the like. The first set of resources, which correspond to communication devices 124a-j and 132a-m, are served directly or supported by the communications server 108 and/or switch 120 and commonly service contacts to the center. In other words, the first set of resources/workstations are subscribers to the enterprise network 100 defined by the contact center or are within the premises 100 serviced by the server 108 and switch 120. The second set of resources/workstations are generally not served and/or supported directly by the central server and are typically geographically dislocated from the first plurality or set of resources. In other words, the second set of workstations/resources are not subscribers to or supported by the enterprise network and are external to the premises serviced by the switch and central server. Communications with these resources are directed through the PSTN 156 (for telephone calls) (and are received at an external port of the switch) and through the untrusted network 140 (e.g., for data communications such as customer-related information transmission and Voice over IP calls). As discussed below, the second set of resources may be used to augment or support the first set of resources, such as by servicing less valuable or profitable work items.

The operation of the architecture an embodiment of the present invention will now be described.

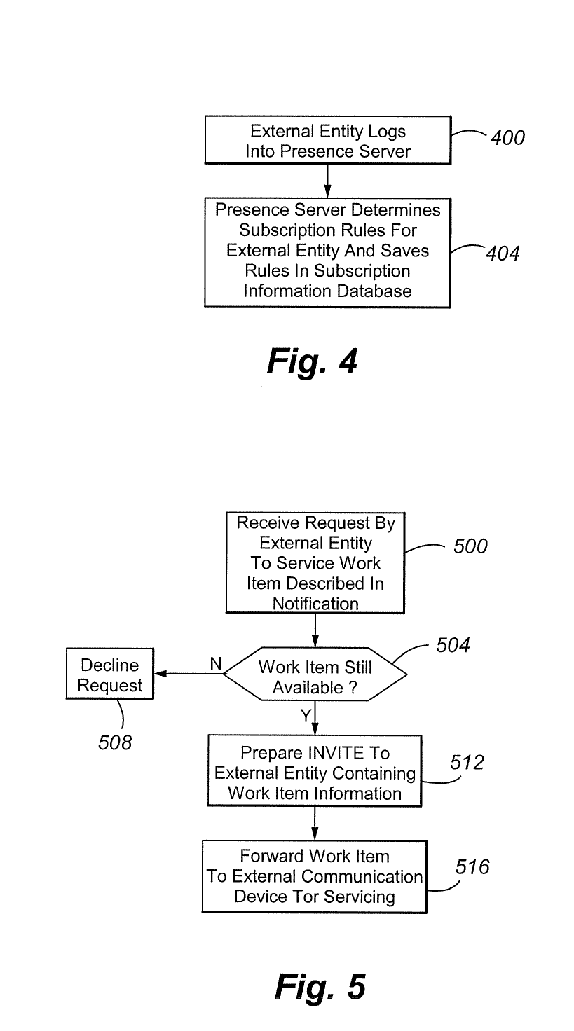

Referring to FIG. 4, the process for subscribing to a set of work item containers is shown.

In step 400, the external entity logs into the presence server. This is typically effected by the resource interacting with the presence aware agent 164 of the resource's communication device to select various work item queues 208 and/or sets of work item containers 212 within a work item queue 208 for subscription. The subscription may occur before the work item container has even been populated, or associated with, an active work item. The subscription to a work item container typically has a longer life than one active work item and often spans the lives of several work items in the selected work item container. The subscription life is often time limited and stipulated by the resource. In one configuration, the subscription life is open ended until terminated by the resource. The subscription terms are preferably obtained from the resource by means of a GUI displayed on the resource's communication device. The GUI may request the resource to select which queues and/or work item containers in those queues he or she wishes to subscribe to. Alternatively, the resource could enter his or her identity or respond to a series of questions and, using the information, the communications server 108 would determine automatically to which queues or sets of work items within a queue the resource is to subscribe.

In step 404, a SUBSCRIBE message containing the resource configured subscription parameters or rules is forwarded by the resource's communication device to the presence server 136. The server 136 reviews the subscription rules in the SUBSCRIBE message and updates the subscription information in the database 140 to indicate which of the work item containers and/or queues to which the resource has subscribed and the terms of the subscription.

As is evident from the foregoing description, the subscription information database 140 includes information respecting subscriptions by internal and external resources. Exemplary subscription information includes the identity of the subscribing entity (e.g., name, employee identification number, IP address, Media Access Control or MAC address, port number, etc.), the work item containers and/or queues that are the subject of the subscription, and the terms of the subscription. Subscriptions terms include duration of the subscription and stipulations on the type of information in the work container that trigger a NOTIFICATION message to the resource's corresponding presence awareness agent. For example, the resource may only wish to be notified of work items from specific customer identities or types, the type of work the resource is interested in (e.g., specific products or services), specific timestamp values, specific actual, estimated, or predicted wait time values, and the like.

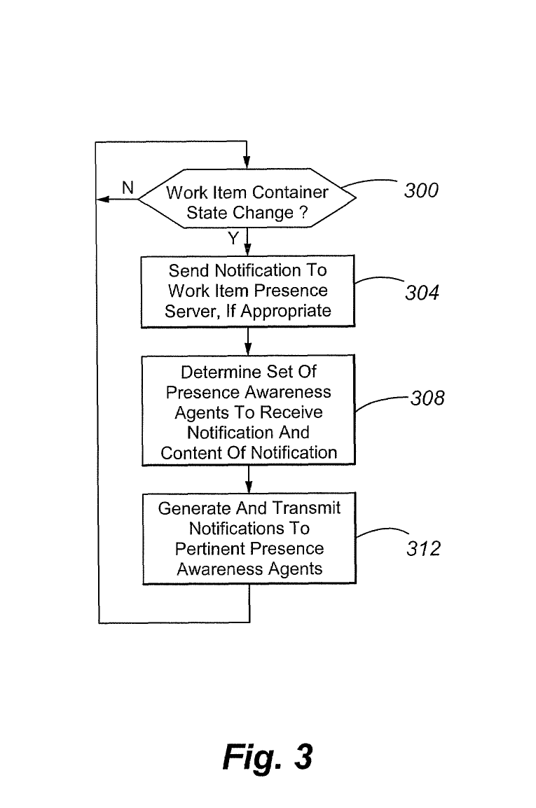

The use of NOTIFY messages will now be described with reference to FIG. 3.

In decision diamond 300, the work item processing agent 200 determines whether a work item container has had a state change. A state change occurs when the work item container is populated with information associated with a work item or when an already populated work item is updated. When there has been no state change during a selected time interval, the agent 200 returns to and repeats decision diamond 300 after a selected time. When there has been a state change during the selected time interval, the agent 200 proceeds to step 304.

In step 304, the work item processing agent 200 sends a NOTIFY message to the presence server 136. Alternatively, a module other than the work item processing agent 200 monitors the work containers and generates NOTIFY messages when a state change occurs. The NOTIFY message contains any of the information noted above. In one configuration, the agent 200 only sends a NOTIFY message when the contact center state requires the assistance of external resources.

In step 308, the presence server 136 receives the NOTIFY message and, based on the subscription information in database 140, determines the set of presence awareness agents having subscription terms requiring them to be notified of the state change and the permissible content of the NOTIFY message. Some resources may be privileged to receive more information than others or resources may elect how much information they wish to receive before transfer of the work item to them.

In step 312, the presence server 136 generates and transmits NOTIFY messages to the set of presence awareness agents identified in step 308.

The recipient external communication devices can then display some or all of the waiting work items for which NOTIFY messages have been received, including detailed information about the work items to assist the resource in using his or her judgment in selecting one or more work items for servicing. In one configuration, the information includes an automatically generated recommendation from the communications server 108 as to which work item should be selected by the resource. The recommendation is generated by the server's internal work item assignment rules engine using conventional techniques.

The process for transferring work items to external resources will now be described with reference to FIG. 5. In the process, the resource has the ability to select any waiting work item to respond to next rather than letting the server 108 make this decision without input of the resource.

Before discussing the transfer, it is helpful to understand that, when a work item such as a contact arrives, the central communications server 108 is notified via LAN 128 of the incoming realtime or non-realtime contact by the telecommunications component (e.g., switch 120, fax server, email server, web server, instant message server, and/or other server) receiving the incoming contact. The incoming contact is held by the receiving telecommunications component until the central communication server 108 forwards instructions to the component to forward the contact to a specific workstation and/or resource. When it receives a notification that a selected work item has arrived and when it has received sufficient information, the work item processing agent 200 populates an empty work item container as noted above and appropriate NOTIFY messages are sent to pertinent presence awareness agents.

In step 500, a request is received by the work item processing agent 200 from an external resource to service a selected work item described in a NOTIFY message. The request is typically received by the external communication device from the resource, via a GUI, and the presence awareness agent 164 in the device generates and sends the request including all or selected parts of the information in the NOTIFY message received in connection with the selected work item.

In decision diamond 504, the agent 200 determines whether the selected work item is still available; that is, it determines whether the selected work item has been assigned to another resource. This is particularly important where the external resources work on a first-come-first-served basis. Alternatively, in a competitive bid situation the agent 200 determines whether the requesting resource is the highest bidder. If the work item is not available to the requesting resource, the agent 200, in step 508, declines the request. If the work item is available to the requesting resource, the agent 200, in step 512, prepares an INVITE to the external entity containing the work item invitation. If the INVITE is accepted, the agent 200, in step 516, forwards the work item to the external communication device of the requesting resource. The agent 200 then deletes the information from the respective work item container so that it may receive a next work item.

A number of variations and modifications of the invention can be used. It would be possible to provide for some features of the invention without providing others.

For example in one alternative embodiment, the external or internal resource is an employee of the enterprise 100 but is normally not assigned to the contact center. He or she may be, for example, a product designer or other type of SME whose availability to be contacted depends on other job responsibilities of the person. By providing periodic NOTIFY messages to the resource's communication device, the SME has the option of assisting in customer service activities as he or she is able.

In another alternative embodiment, the present invention is used for load balancing or off loading overflow work. In this implementation, external entities, such as communication devices and servers/switches, subscribe to an overflow queue or to higher work item container numbers in a queue that is populated first at the head of the queue and last at the tail of the queue. When a work item container having a number that is a selected number or higher (or is closer to the tail of the queue) is populated, the agent 200 sends a NOTIFY message to the subscribing entity. When a work item container has number that is lower than the selected number (or is closer to the head of the queue) is populated, the agent 200 does not send a NOTIFY message as the message will be handled by internal resources.

In yet another embodiment, dedicated hardware implementations including, but not limited to, Application Specific Integrated Circuits or ASICs, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be stated that the software implementations of the present invention are optionally stored on a tangible storage medium, such as a magnetic medium like a disk or tape, a magneto-optical or optical medium like a disk, or a solid state medium like a memory card or other package that houses one or more read-only (non-volatile) memories. A digital file attachment to e-mail or other self-contained information archive or set of archives is considered a distribution medium equivalent to a tangible storage medium. Accordingly, the invention is considered to include a tangible storage medium or distribution medium and prior art-recognized equivalents and successor media, in which the software implementations of the present invention are stored.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease andor reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. In a contact center comprising a plurality of work item containers, each work item container associated with a respective work item to be serviced and including information associated with the respective work item, and operating such that, when a state of a selected work item container changes, a set of entities that subscribed to be notified of a state change in the selected work item and/or corresponding work item container is determined, and each of the members of the set of entities is notified of the state change by a subscription notification, an improvement comprising the subscription notification including an applet that is downloaded onto at least one entity corresponding to a resource, the at least one entity being a computational device and the applet interacting with the resource to assist the resource (a) in selecting the work item and/or work item container referenced in the subscription notification for servicing and/or (b) in servicing of the selected work item andor work item container.

2. The method of claim 1, wherein the applet provides the resource with at least some of the following information for the work item and/or work item container referenced in the subscription notification: contacting customer identity, customer type, work item intent or purpose, customer personal information, customer transaction history, work item browser history, customer order details, customer contact mode, timestamp, work item priority, expected wait time, actual wait time, predicted wait time, identification of at least one other switch location having resources that may be able to receive the waiting work item, a Universal Resource Locator or URL associated with the work item, and a pointer to the current location of the contact.

3. The method of claim 1, wherein the applet comprises a link to the work item container referenced in the subscription notification.

4. The method of claim 1, wherein the applet comprises at least one of an address and link to a hosted query engine operable to prompt the resource for what further information to get from a customer associated with the work item and/or work item container referenced in the subscription notification, instruct the resource how to respond to questions and answers received from the customer, and/or provide the resource with an interface to provide the hosted query engine with information received from the customer.

5. The method of claim 1, wherein the applet comprises a mechanism for the resource to prompt the customer for information and/or requests and input the information and/or requests into a database of the contact center without the need of a secondary link to cause an associated action by the resource or another resource on a computer terminal of the contact center.

6. The method of claim 1, wherein the applet provides the resource with information sufficient for the resource to service the selected work item without the need of a secondary link for data for retrieval or update.

7. The method of claim 1, wherein the applet comprises instructions in the form of a graphical user interface display having fields that are populated by the resource when servicing the selected work item and/or work item container referenced in the subscription notification.

8. The method of claim 7, wherein the populated instructions are pushed back to a contact center server, the contact center server then updates a contact center database with the populated fields and wherein the at least one communication device of the resource is not a part of an enterprise network maintained by the contact center.

9. A computer readable medium comprising processor executable instructions for performing the steps of claim 1.

10. In a contact center comprising an input operable to receive work items, a work item processing agent operable to populate work item containers with information respecting the received work items, and a notification agent operable to notify subscribing entities by a subscription notification of state changes in the work item items and/or work item containers, the processing agent transferring work items to a subscribing entity when requested by the subscribing entity, an improvement comprising the subscription notification including an applet that is downloaded onto at least one entity corresponding to a resource, the at least one entity being a computational device and the applet interacting with the resource to assist the resource (a) in selecting the work item and/or work item container referenced in the subscription notification for servicing and/or (b) in servicing of the selected work item and/or work item container.

11. The contact center of claim 10, wherein the applet provides the resource with at least some of the following information for the work item and/or work item container referenced in the subscription notification: contacting customer identity, customer type, work item intent or purpose, customer personal information, customer transaction history, work item browser history, customer order details, customer contact mode, timestamp, work item priority, expected wait time, actual wait time, predicted wait time, identification of at least one other switch location having resources that may be able to receive the waiting work item, a Universal Resource Locator or URL associated with the work item, and a pointer to the current location of the contact.

12. The contact center of claim 10, wherein the applet comprises a link to the work item container referenced in the subscription notification.

13. The contact center of claim 10, wherein the applet comprises at least one of an address and link to a hosted query engine operable to prompt the resource for what further information to get from a customer associated with the work item and/or work item container referenced in the subscription notification, instruct the resource how to respond to questions and answers received from the customer, and/or provide the resource with an interface to provide the hosted query engine with information received from the customer.

14. The contact center of claim 10, wherein the applet comprises a mechanism for the resource to prompt the customer for information and/or requests and input the information and/or requests into a database of the contact center without the need of a secondary link to cause an associated action by the resource or another resource on a computer terminal of the contact center and wherein the applet provides the resource with information sufficient for the resource to service the work item and/or work item container referenced in the subscription notification without the need of a secondary link for data for retrieval or update.

15. The contact center of claim 10, wherein the applet comprises instructions in the form of a graphical user interface display having fields that are populated by the resource when servicing the work item and/or work item container referenced in the subscription notification, wherein the populated instructions are pushed back to a contact center server, the contact center server then updates a contact center database with the populated fields, and wherein the at least one communication device of the resource is not a part of an enterprise network maintained by the contact center.

16. In a contact center comprising a plurality of work item containers, each work item container associated with a work item for servicing and including information related to the respective work item, and operating such that, when a state of a selected work item container changes, a set of computational entities that subscribed to be notified of a state change in the selected work item is determined, and each of the members of the set of entities is notified of the state change by a subscription notification, an improvement comprising:
in response to a resource selecting for servicing a work item described in a subscription notification, downloading an applet onto at least one communication device of the resource; and
the applet thereafter interacting with the resource, during servicing of the selected work item, to assist the resource and/or collect information from the resource.

17. The method of claim 16, wherein the applet provides the resource with at least some of the following information for the work item: contacting customer identity, customer type, work item intent or purpose, customer personal information, customer transaction history, work item browser history, customer order details, customer contact mode, timestamp, work item priority, expected wait time, actual wait time, predicted wait time, identification of at least one other switch location having resources that may be able to receive the waiting work item, a Universal Resource Locator or URL associated with the work item, and a pointer to the current location of the contact and wherein the applet comprises a link to the work item container associated with the work item.

18. The method of claim 16, wherein the applet comprises at least one of an address and link to a hosted query engine operable to prompt the resource for what further information to get from a customer associated with the work item, instruct the resource how to respond to questions and answers received from the customer, and/or provide the resource with an interface to provide the hosted query engine with information received from the customer.

19. The method of claim 16, wherein the applet comprises a mechanism for the resource to prompt the customer for information and/or requests and input the information and/or requests into a database of the contact center without the need of a secondary link to cause an associated action by the resource or another resource on a computer terminal of the contact center.

20. The method of claim 16, wherein the applet comprises instructions in the form of a graphical user interface display having fields that are populated by the resource when servicing the selected work item and wherein the populated instructions are pushed back to a contact center server, the contact center server then updates a contact center database with the populated fields.

21. The method of claim 20, wherein the at least one communication device of the resource is not a part of an enterprise network maintained by the contact center.

22. A computer readable medium comprising processor executable instructions for performing the steps of claim 16.
